(19) United States
(12) Patent Application Publication
(10) Pub. No.: US 2008/0251110 A1
(43) Pub. Date: Oct. 16, 2008

(54) Walking Aid for a Visually Disabled Person

(76) Inventor: Giuseppe Pede, Toronto (CA)

Correspondence Address: Elias Borges, Suite 406, 555 Burnhamthorpe Road, Toronto, ON, M9C 2Y3, CA

(21) Appl. No.: 12/045,076

(22) Filed: Mar. 10, 2008

Related U.S. Application Data
(60) Provisional application No. 60/907,632, filed on Apr. 12, 2007.

(51) Int. Cl. A61H 3/06; G01C 21/00

(52) U.S. Cl. 135/66; 701/200

(57) ABSTRACT

A walking aid for assisting a visually disabled user is provided. The walking aid consists of an elongated housing having a handle at one end and a distal end opposite the handle. A wheel is mounted to the distal end of the housing, the wheel being mounted to the housing by a swivel mount permitting the wheel to swivel in any direction in response to the user moving the walking aid. The length of the housing is selected such that the user can comfortably hold the handle of the walking aid while walking with the wheel supporting the housing by rolling along the ground. The housing contains a cell phone which is coupled to an earphone and microphone interface worn by the user. The earphone/microphone interface permits the user to operate the cell phone device to make and receive telephone calls. A GPS unit is contained in the housing. The GPS unit has a voice interface which is configured to receive a plurality of operating instructions as voice commands. The voice interface is further configured to transmit GPS information, such as location, direction of travel, speed and directions as voice messages. The earphone and microphone interface is configured to couple to the GPS unit such that the user can transmit voice commands to the GPS unit through the microphone and the GPS unit can transmit the voice messages to the user through the earphone.

### CROSS REFERENCE TO RELATED APPLICATION

The present application claims the benefit of U.S. provisional application No. 60/907,632 filed Apr. 12, 2007, the entirety of which is incorporated herein by reference.

### FIELD OF THE INVENTION

The invention relates generally to walking aids for visually disabled people.

### BACKGROUND OF THE INVENTION

Visually disabled people have a great deal of trouble traveling independently. Being unable to see, it is difficult for visually disabled people to safely cross streets, enter and exit buildings, or even walk down a crowded street. Most visually impaired people are often intimidated by the numerous hazards and obstacles which can interfere with the safe navigation of an urban center. For example, crossing an intersection displaying a green light is a trivial matter for a sighted person, but for someone suffering from visual impairment it is a daunting challenge. Firstly, there is usually no way a visually impaired person can make out if the intersection light is green or not. Then, it is often difficult for the visually impaired person to locate the exact location of the street curb so that he/she does not stumble and to orient themselves correctly so that they cross the intersection in the right direction. There is also the real fear that the visually impaired person may bump into another pedestrian, stumble on a pot hole or accidentally walk into oncoming traffic. As a result, most people who suffer severe visual impairment wait for a sighted person to assist them in crossing the street. Even walking down the street to a store can be quite difficult for a sightless person because it is nearly impossible to maintain the correct orientation while walking to ensure that one does not walk off the sidewalk. In addition to pedestrian traffic, urban streets are often dotted with obstacles such as post boxes, garbage cans, signs, poles and the like. Potholes, cracks in the pavement and street curbs are other obstacles which a sightless person must try to avoid while walking. Since it is all but impossible to read street signs or other location clues without at least some vision, it is also quite easy for a visually impaired person to become lost and disoriented when walking even a short distance. As a result, visually impaired people have a tendency to refrain from traveling outside the home.

A variety of aids have been introduced to try to increase the mobility of visually impaired people. The white cane was introduced decades ago to provide some level of sensory input for a blind (or visually impaired) person. With the cane, a person can avoid walking into objects such as walls or post boxes and may even be able to “feel” the location of street curves. While helpful, canes have limited applicability. Firstly, they are generally unable to sense pot holes or small obstructions in the pavement ahead. They can not be used to properly orient an individual to ensure that the individual walks in the right direction and they cannot warn against an obstruction which is more than a meter away.

Seeing eye dogs are another innovation which h oneself in the right which may add to the sense of helplessness and vulnerability which the visually impaired person may experience. These specially trained dogs can greatly increase a person's mobility. A properly trained dog can help the user avoid obstacles and avoid traffic. They do have a series of limitations, however. In addition to the amount of maintenance that they require, trained dogs cannot communicate the user's location, cannot ward the user when they have walked passed the desired destination and they cannot provide the user with instructions when the user is lost. As a result, an improved walking aid for use by visually impaired users is desired.

### SUMMARY OF THE INVENTION

The present invention is a walking aid for assisting a visually disabled user which overcomes the disadvantage of the prior art. The walking aid consists of an elongated housing having a handle at one end and a distal end opposite the handle. A wheel is mounted to the distal end of the housing, the wheel being mounted to the housing by a swivel mount permitting the wheel to swivel in any direction in response to the user moving the walking aid. The length of the housing is selected such that the user can comfortably hold the handle of the walking aid while walking with the wheel supporting the housing by rolling along the ground. The housing contains a cell phone which is coupled to an earphone and microphone interface worn by the user. The earphone/microphone interface permits the user to operate the cell phone device to make and receive telephone calls. A GPS unit is contained in the housing. The GPS unit has a voice interface which is configured to receive a plurality of operating instructions as voice commands. The voice interface is further configured to transmit GPS information, such as location, direction of travel, speed and directions as voice messages. The earphone and microphone interface is configured to couple to the GPS unit such that the user can transmit voice commands to the GPS unit through the microphone and the GPS unit can transmit the voice messages to the user through the earphone.

### DESCRIPTION OF THE DRAWINGS

FIG. 1. is a perspective view of a walking aid made in accordance with the invention showing the end portion in its first and second positions.

FIG. 2. is a side view of a person wearing the headphone portion of the present invention.

FIG. 3 is a schematic view of the cell phone, GPS unit, obstacle detector and communications interface portions of the present invention.

In the drawings like characters of reference indicate corresponding parts in the different figures.

### DETAILED DESCRIPTION OF THE INVENTION

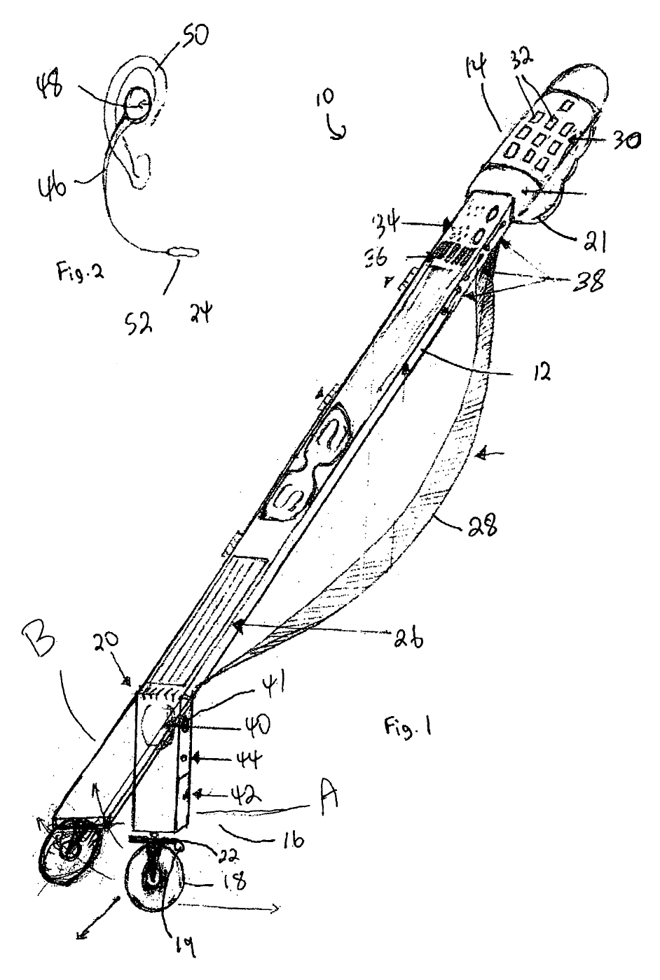

Referring firstly to FIG. 1, a walking aid for use by a visually impaired or blind person made in accordance with the present invention is shown generally as item 10 and consists of an elongated shaft (housing) 12 having handle portion 14 and pivoting end portion 16. A swivelling wheel 18 is movably connected to pivoting end 16, which is in turn pivotally connected to shaft 12 via pivotal connection 20. Wheel 18 is movably connected to end 16 by means of swivel connector 22 such that the wheel can swivel around in any direction. Swivel connectors suitable for use as connector 22 are readily available on the market. Pivotal connector 20 is configured to permit end 16 to pivot between a lowered position as shown in FIG. 1 (item A) wherein end 16 is at an angle relative to shaft 12 and an extended position (item B) wherein end 16 and shaft 12 are coaxially aligned and straight. The device is provided with a lock mechanism (not shown) for locking the walking stick in either its angled or extended positions. The lock mechanism may comprise a simple latch which locks the device in either its angled or extended position. Various locking mechanisms suitable for use in locking the device in either position are readily found in the market. The lengths of housing 12 and end portion 16, and the angle between end portion 16 and housing 12 are all selected such that when the device is in its angled position, the device can be comfortably held by the user so that end portion 16 is substantially vertically oriented.

The device also has a brake mechanism 19 operatively coupled to wheel 18 and to brake leaver 21. When break leaver 21 is engaged, the break mechanism locks wheel 18 in place, preventing the wheel from turning. Brake mechanism 19 preferably comprises a brake caliper as found in bicycles which can be engaged by a pulling on a brake cable (not shown) which runs along housing 12 to bake leaver 21. Squeezing brake lever 21 causes tension to be applied to the brake cable which in turn causes the brake caliber 19 mounted adjacent wheel 18 to brake. Brake mechanism using calipers and cables are available in the marketplace.

Shaft 12 is provided with clips 24 for mounting a standard folding walking stick (not shown). Solar panels 26 are provided on shaft 12 to provide electrical power to the various components of the apparatus, as shall be more completely described later. Strap 28 is also provided on shaft 12 to make the aid easier to carry. Preferably, shaft 12 is made of extruded aluminum or some other sturdy by light material such as plastic.

Shaft 12 houses a number of useful devices which add synergistically to the usefulness of the walking aid. For example, hand portion 14 contains a built in cell phone 30 which is enclosed in a water proof compartment located adjacent the handle. Buttons 32 are positioned on handle 14 to enable the user to quickly and easily access the cell phone when required. GPS unit 34 is also provided in a water proof compartment contained within shaft/housing 12. The GPS unit is preferably coupled to an emergency communication and navigation system similar to those used with the ON STAR™ system to permit the user to receive not only position information but also to transmit information to a remote control center in the event of an emergency. As shall more particularly be explained below, GPS unit 34 has a voice interface which is configured to receive operating instructions as voice commands and to transmit GPS information, such as location, direction of travel, speed and directions as voice messages. Cell phone 30 may also have a radio feature, or alternatively, a separate am-fm or even satellite radio may be built into a water tight compartment in shaft 12. Cell phone 30 and GPS unit 34 (along with any radio device) are operatively coupled to speaker 36 so that the user can hear either the cell phone conversation or the GPS voice messages. Volume, tuner and on/off switches 38 are positioned adjacent handle 14 to make them readily accessible to the user.

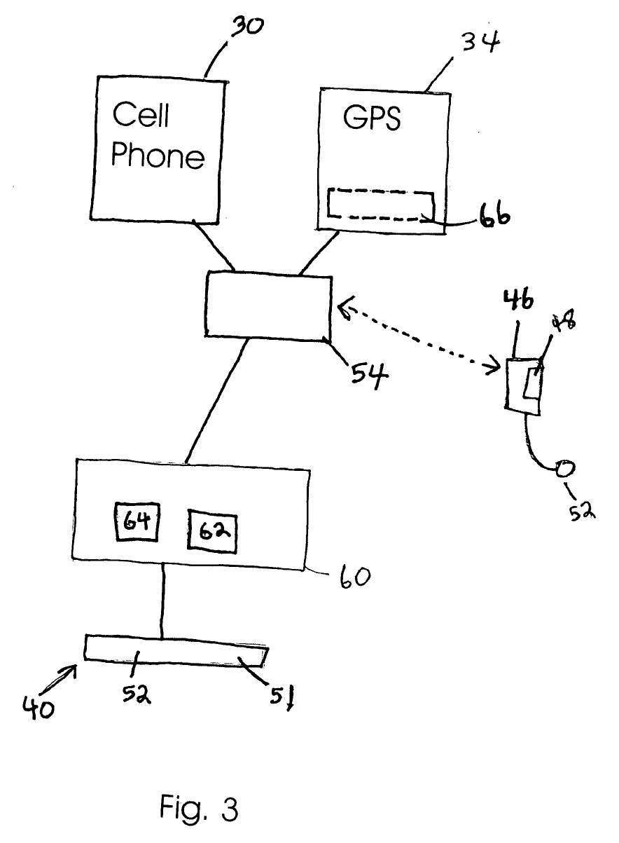

End portion 16 is provided with an obstacle detection device 40 which is adapted and configured to warn of any object a few meters in front of the detection device. Since end portion 16 is substantially vertically oriented when the device is placed in its angled orientation, detection device can be used to detect objects immediately in front of the walking aid device, such as stairs or a curb. Obstacle detection device 40 may comprise cluster of several different sensors including one or more simple infrared LED-sensor pairs. Each LED-sensor pair includes an infrared LED for directionally beaming an infrared signal in front of device 10 and an infrared sensor for sensing any of the infrared signal which has been reflected back. Suitable infrared LEDs and sensors are available in the market. As more particularly described below, detection device 40 is coupled to a control module 60 (see FIG. 3) which is configured to generate an audible warning when an obstacle is detected in front of detection device 40. Electronic sensor device 40, cell phone 30 and GPS unit 34 are all powered by rechargeable batteries contained in battery compartment 42. The rechargeable batteries contained in battery compartment 42 may be recharged by plugging in recharging port 44 into a suitable power source. The charge in the rechargeable batteries operating the device can be augmented by solar panels 24, particularly on sunny days.

Ear piece 46 is a combination speaker and microphone interface which is wearable by the user. Ear piece 46 is operatively coupled to cell phone 30, GPS unit 34 and electronic sensor 40 via a wireless connection system such as blue tooth. Ear piece 46 is worn on the user's ear 50 and includes speaker 48 and microphone 52. The ear piece is adapted to receive audio information from the electronic sensor 40, the cell phone 30 and the GPS unit 34 and permits the user to interact with the cell phone and GPS units simply by talking into microphone 52. By coupling all three sub-devices into earpiece 46, the user can be warned of an impending obstacle via sensor 40 while listening to GPS directions, listening to the radio or having a cell phone conversation. The user can also discreetly receive navigational information from the GPS unit via earpiece 46.

The device is also provided with side viewing obstacle detection sensors 41, preferably optical sensors, which are adapted and configured to warn of any obstacles located on the sides of the device. Obstacle detection sensors 41 are substantially the same design as electronic sensor 40. Electronic sensors 40 and 41 are also capable of relaying basic information to the user concerning such things as light density or day/night status. Optical sensor 40 is capable of detecting sudden changes in elevation in front of the device. Temperature sensors may also be coupled to these optical sensors to provide the user with an audible signal signifying the ambient air temperature.

Optical sensor 40 may also be configured to include photo sensors to sense a particular frequency of light corresponding to a green or red traffic light such that the sensor will send a different electronic signal to control module 60 when the sensor detects either a green or red traffic light. Control module 60 may be configured to send a different audible alarm depending on whether sensor 40 measures a red or green traffic light. Photo sensors (detectors) which are sufficiently specific and sensitive to detect wavelengths of light corresponding to green and red traffic lights are available in the market.

Referring now to FIG. 3, obstacle detector 40 may comprise any optical or ultra sonic detector capable of generating an alarm signal when an object is placed in front of the detector. Numerous optical, infra red and ultra sonic object detectors are readily available in the marketplace which can be used for the present invention. One possible obstacle detector is illustrated and includes an infra red LED 51 configured to project an IR signal and an infra red detector 52 configured to receive the IR signal which is reflected back towards detector 40. LED 51 and infra red detector 52 are coupled to control module 60 which contains an LED driver 62 and a signal multiplier 64. Drive 62 is configured to drive LED 51 to project an IR signal and signal multiplier 64 is configured to monitor infra red detector 52 for the IR signal reflected back towards detector 40. Control module 60 is configured to measure the time interval between when an IR signal is projected from LED 51 and when the reflected IR signal is detected by detector 52. Control module 60 is further configured to generate an alarm signal when the time interval between projected and reflected IR signals falls below a predetermined interval, indicating that an object is a preselected distance in front of detector 40. Control module 60 is coupled to wireless interface 54, which is in turn wirelessly coupled to earphone/microphone interface 46. Control module 60 and wireless interface 54 are configured such that when control module 60 generates an alarm signal, the alarm signal is broadcast by wireless interface 54 and picked up by interface 46.

Wireless interface 54 is also coupled to cell phone 30 and GPS unit 34. GPS unit 34 has a voice interface 66 which is configured to receive operating instructions as voice commands and to transmit GPS information as voice messages. Several GPS units currently on the market have built in voice interfaces which are suitable for use in the present invention. Likewise, cell phone 30 has a built in voice interface which is configured to permit the user to dial a number simply by issuing a voice command, such as “Call Home”. Again, several cell phones having built in voice interfaces and which are suitable for use with the present invention are available on the market.

Wireless interface 54 is preferably a blue tooth transmitter device. Blue tooth interface transmitters are readily available in the marketplace for use with cell phones, GPS units, computers, and the like. The advantage of blue tooth interfaces is that they provide an industry standard interface which can easily be adapted for use by several different devices. Preferably, blue tooth interface 54 is configured to permit all three devices, namely cell phone 30, GPS unit 34 and obstacle detector 40 to transmit and receive to earphone/microphone interface 46 simultaneously.

The present invention provides a very convenient aid to visually impaired or sightless people. By incorporating a cell phone device with a GPS unit, an electronic eye and a wireless earpiece, the user can feel more secure that he or she has all that they need in order to go about their day with safety and confidence simply by taking the walking aid. The device provides the user with navigational information permitting the user to know in which direction to travel, whether or not he/she is traveling in the right direction, when to turn right or left, and when the desired destination has been reached. By receiving this GPS information as voice messages through an earphone worn by the user, the user is better able to clearly receive and comprehend the GPS information in a noisy city street. In the event of an emergency, of if the user becomes disoriented, lost or confused, the user can simply engage the cell phone to make a telephone call or log onto the emergency navigational assistance system to receive aid from a remote operator.

The device also provides the user with immediate navigational information such as when an obstacle is being approached. The wheel being mounted to the front of the device provides the user with second by second tactile information about the condition of the sidewalk immediately ahead. If a pot hole or crack in the pavement are present in front of the device, the wheel will bump on the hole or crack, thereby warning the user to take immediate precautions to avoid stumbling. The wheel also makes the device easier to carry since the wheel supports the device on the ground.

The GPS unit, cell phone, electronic sensors, and wheel interact synergistically to provide the user with a superior navigational aid. The electronic sensors and wheel provide the user with short range navigational information which helps the user avoid immediate and relatively short range obstacles, thereby providing the user with an increased sense of security because he/she is less likely to stumble, fall or collide with pedestrians or other objects. The GPS unit provides the user with longer range navigational information as well as directional information. Since the electronic sensors and GPS unit are both coupled to the combination earphone/microphone interface, the user can receive warnings concerning short range obstacles while listening to navigational information. This would not be as easily achieved if these devices are provided separately. Since the cell phone is likewise coupled to the earphone/microphone interface, the user can also engage in a cell phone conversation while receiving both GPS information and warnings from the electronic obstacle detectors. Again, it would be difficult for the user to operate all three devices simultaneously if these devices were provided separately.

The device also permits the user to use the device for interacting with a computer (not shown) via the blue tooth interface to permit the user to receive information from the computer via the earpiece. This requires the computer being used (not shown) to also be equipped with a blue tooth interface and would permit the user to use the computer to navigate the internet for such purposes as long distance learning, shopping or gathering information. The user can use the computers keyboard and mouse (not shown) to navigate through various web pages provided the computer is loaded with a suitable web browser capable of audibly reproducing the information contained in the web page to which the browser is pointed. In this way, the device becomes an invaluable tool which greatly increases the scope of the users abilities.

It will be appreciated that the present invention can also be used in a more compact form in combination with a wheel chair to provide aid and assistance to a disabled person who may, or may not, be blind. In such a case, the device would not have an elongated housing but rather a compact housing containing the gps unit, blue tooth unit, cell phone and control module.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

We claim:

1. A walking aid for assisting a visually disabled user comprising;
an elongated housing having a handle at one end and a distal end opposite the handle;
a wheel mounted to the distal end of the housing, the wheel being mounted to the housing by a swivel mount permitting the wheel to swivel in any direction;
the housing having a length selected such that the user can comfortably hold the handle of the walking aid while walking with the wheel supporting the housing;
a cell phone contained within the housing;
an earphone and microphone interface configured to be wearable by the user, the earphone and microphone interface configured to couple to the cell phone to permit the user to operate the cell phone through the earphone and microphone interface;
a gps unit contained within the housing, the gps unit having a voice interface configured to receive a plurality of operating instructions as voice commands from the user and for transmitting gps information to the user as voice messages;
the earphone and microphone interface configured to couple to the gps unit such that the user can transmit the voice messages to the gps unit and to receive the gps information from the gps unit.

2. The walking aid defined in claim 1 wherein the earphone and microphone interface is wirelessly coupled to the gps unit and the cell phone.

3. The walking aid of claim 1 wherein the housing has an end portion mounted to the housing at the distal end, the wheel being mounted to the end portion via the swivel mount, the end portion being pivotally mounted to the distal end of the housing and movable between a first position wherein the end portion is substantially coaxially aligned with the housing and a second position wherein the end portion is at an angle relative to the housing, the housing having a locking mechanism for releasably locking the end portion in its first and second positions.

4. The walking aid of claim 3 wherein the end portion has a length and wherein the length of the end portion, the length of the housing and the angle are all selected such that the end portion can be comfortably held in a substantially vertical orientation by the user holding onto the handle when the end portion is in its second position.

5. The walking aid of claim 1 wherein the walking aid further includes an electronic obstacle detection sensor coupled to a control module, the electronic detection sensor and control module being configured to generate an audible warning signal when an obstacle is detected adjacent the walking aid, the earphone and microphone interface configured to couple to the control module to convey the audible warning signal to the user.

6. The walking aid of claim 4 wherein the walking aid further includes an electronic obstacle detection sensor coupled to a control module, the obstacle detection sensor being mounted to the end portion of the housing, the electronic detection sensor and control module being configured to generate an audible warning signal when an obstacle is detected in front of the walking aid, the earphone and microphone interface configured to couple to the control module to convey the audible warning signal to the user.

7. The walking aid of claim 5 wherein the obstacle detection sensor is an optical sensor.

8. The walking aid of claim 6 wherein the obstacle detection sensor is an optical sensor.

9. The walking aid of claim 6 further comprising a brake for braking the wheel and preventing it from rotating, the brake having a brake level for engaging the brake, the brake lever being mounted adjacent the handle such that the brake can be engaged by the user while the user holds onto the handle.

10. The walking aid of claim 1 wherein the housing has a mount for releasably mounting a walking stick to the housing.

11. The walking aid of claim 1 wherein the housing has a strap for carrying the device.

12. A navigation aid for assisting a disabled user comprising;
a housing;
a cell phone contained within the housing;
an earphone and microphone interface configured to be wearable by the user, the earphone and microphone interface configured to couple to the cell phone to permit the user to operate the cell phone through the earphone and microphone interface;
a gps unit contained within the housing, the gps unit having a voice interface configured to receive a plurality of operating instructions as voice commands from the user and for transmitting gps information to the user as voice messages;
the earphone and microphone interface configured to couple to the gps unit such that the user can transmit the voice messages to the gps unit and to receive the gps information from the gps unit.
